(19) United States
(12) Patent Application Publication
(10) Pub. No.: US 2025/0083510 A1
(43) Pub. Date: Mar. 13, 2025

(54) STRUCTURAL CROSSMEMBER WITH BATTERY PACK MOUNTING FOR VEHICLE

(71) Applicant: Atieva, Inc., Newark, CA (US)

(72) Inventor: Andrew Charles Nisbet, Menlo Park, CA (US)

(21) Appl. No.: 18/557,488

(22) PCT Filed: Oct. 28, 2022
(86) PCT No.: PCT/US2022/078876

§ 371 Date: Oct. 26, 2023

(51) Int. Cl. B60K 1/04; B62D 25/20; H01M 50/249; H01M 50/262

(52) U.S. Cl. CPC B60K 1/04; B62D 25/2036; H01M 50/249; H01M 50/262; B60K 2001/0438

(57) ABSTRACT

A structural crossmember with battery pack mounting for a vehicle comprises: a crossmember configured to extend between a first side sill of a vehicle body and a second side sill of the vehicle body across from the first side sill, the crossmember having (i) a first linear portion with a distal end at the first sill, (ii) a second linear portion with a distal end at the second side sill, and (iii) an arched portion that couples respective proximate ends of the first and second linear portions to each other; a first mount for a passenger cabin component, the first mount positioned on a first side of the crossmember facing toward a passenger cabin of the vehicle; and a second mount for the battery pack, the second mount positioned on a second side of the crossmember opposite from the first side.

### TECHNICAL FIELD

This document relates to a structural crossmember with battery pack mounting for a vehicle.

### BACKGROUND

Modern vehicle designs are influenced by the increasing emphasis on vehicle crash safety that characterizes today's automotive manufacturing industry. At the same time, the redirection of the industry's focus towards sustainable transportation, predominantly electric vehicles having battery packs, also affects the needs and possibilities of vehicle safety design.

### SUMMARY

In a first aspect, a structural crossmember with battery pack mounting for a vehicle comprises: a crossmember configured to extend between a first side sill of a vehicle body and a second side sill of the vehicle body across from the first side sill, the crossmember having (i) a first linear portion with a distal end at the first sill, (ii) a second linear portion with a distal end at the second side sill, and (iii) an arched portion that couples respective proximate ends of the first and second linear portions to each other; a first mount for a passenger cabin component, the first mount positioned on a first side of the crossmember facing toward a passenger cabin of the vehicle; and a second mount for the battery pack, the second mount positioned on a second side of the crossmember opposite from the first side.

Implementations can include any or all of the following features. The crossmember further comprises a first mating interface configured for interfacing with a first floor component, and a second mating interface configured for interfacing with a second floor component, the first and second floor components being alternatives to each other for the vehicle. The first floor component corresponds to the vehicle having a non-cavity footwell. The second floor component corresponds to the vehicle having a cavity footwell. The first mount comprises first and second seat rail mounts. The first and second mating interfaces are positioned between the first and second seat rail mounts. The crossmember further comprises a flange on the first side, the flange substantially parallel with a floor of the vehicle. The flange comprises respective single flanges on the first and second linear portions. The flange comprises a dual flange on the arched portion. The structural crossmember further comprises one of a receptacle or pin configured for the structural crossmember to serve as a master datum for the battery pack, wherein the battery pack has the other of the receptacle or the pin. The structural crossmember has two receptacles corresponding to two respective pins that are located on the battery pack, one of the receptacles being a circular opening and the other receptacle being an elongated opening oriented in a y-direction of the vehicle.

In a second aspect, a vehicle comprises: a vehicle body comprising a first side sill positioned across from a second side sill, the vehicle body having a passenger cabin floor between the first and second side sills; a battery pack mounted below the passenger cabin floor, the battery pack having a side-to-side valley; and a structural crossmember configured to extend between the first and second side sills, wherein at least part of the structural crossmember is positioned within the side-to-side valley.

Implementations can include any or all of the following features. The crossmember further comprises a first mating interface configured for interfacing with a first floor component, and a second mating interface configured for interfacing with a second floor component, the first and second floor components being alternatives to each other for the vehicle. The battery pack is configured for the vehicle to have a non-cavity footwell, and wherein the first floor component corresponds to the non-cavity footwell. The battery pack is configured for the vehicle to have a cavity footwell, and wherein the second floor component corresponds to the cavity footwell. The structural crossmember further comprises a first mount for a passenger cabin component, the first mount positioned on a first side of the crossmember facing toward a passenger cabin of the vehicle. The first mount comprises first and second seat rail mounts. First and second mating interfaces are positioned between the first and second seat rail mounts. The structural crossmember comprises (i) a first linear portion with a distal end at the first sill, (ii) a second linear portion with a distal end at the second side sill, and (iii) an arched portion that couples respective proximate ends of the first and second linear portions to each other. The vehicle body further comprises a first floor panel, and wherein the structural crossmember further comprises a flange for interfacing the first floor panel. The flange comprises respective single flanges on the first and second linear portions interfacing the first floor panel. The vehicle body further comprises a second floor panel, and wherein the flange comprises a dual flange on the arched portion, the dual flange comprising a first flange interfacing the first floor panel, and a second flange interfacing the second floor panel. The structural crossmember further comprises one of a receptacle or pin configured for the structural crossmember to serve as a master datum for the battery pack, wherein the battery pack has the other of the receptacle or the pin. The structural crossmember has two receptacles for two respective pins on the battery pack, one of the receptacles being a circular opening and the other receptacle being an elongated opening oriented in a y-direction of the vehicle. The structural crossmember further comprises mounts for the battery pack, and wherein battery pack further comprises fixing points corresponding to the mounts.

### BRIEF DESCRIPTION OF DRAWINGS

FIG. 1A shows a perspective view of an example of a structural crossmember.

FIG. 1B shows examples of the slot and hole of the structural crossmember of FIG. 1A.

FIG. 2 shows a rear view of the structural crossmember of FIG. 1A.

FIG. 3 shows an example of a vehicle with the structural crossmember of FIG. 1A.

FIGS. 4-5 schematically show examples of battery packs with a cavity footwell and a non-cavity footwell, respectively.

FIG. 6 shows the vehicle of FIG. 3 having a non-cavity footwell and a floor member interfacing with the structural crossmember of FIG. 1A.

FIG. 7 shows the vehicle of FIG. 3 having a cavity footwell and a floor member interfacing with the structural crossmember of FIG. 1A.

FIG. 8 schematically shows a cross section of a footwell having the floor members of FIGS. 6-7.

FIGS. 9-10 show example cross sections of the structural crossmember of FIG. 1A.

Like reference symbols in the various drawings indicate like elements.

### DETAILED DESCRIPTION

This document describes examples of systems and techniques for a structural crossmember that provides a cross-vehicle loadpath and also serves to mount a battery pack and other vehicle components. The structural crossmember can tie the vehicle body to the battery pack and to seat rails to form a structural loadpath while also serving mounting purposes. For example, having seats supported by a structural crossmember rather than by the battery pack can ensure that the seat is supported also during service when the battery pack may be temporarily removed from the vehicle. A structural crossmember can provide other advantages, such as to facilitate the flexibility of a vehicle to have alternative design configurations.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

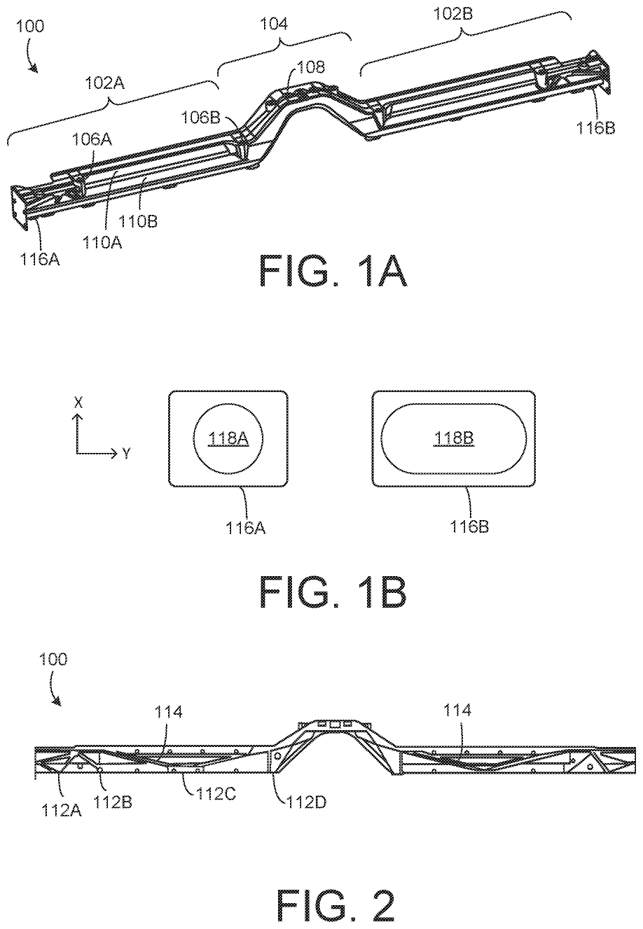

FIG. 1A shows a perspective view of an example of a structural crossmember 100. FIG. 1B shows examples of the slot and hole of the structural crossmember 100 of FIG. 1A. FIG. 2 shows a rear view of the structural crossmember 100 of FIG. 1A. The structural crossmember 100 can be used with one or more other examples described elsewhere herein. The structural crossmember 100 can be made from a material of sufficient strength to serve as a cross-vehicle loadpath, including but not limited to one or more metals. In some implementations, the structural crossmember 100 is made of aluminum (e.g., an aluminum alloy). For example, the structural crossmember 100 can be cast from aluminum.

The structural crossmember 100 can include linear portions 102A-102B and an arched portion 104. The linear portion 102A can have a distal end (here the end opposite the arched portion 104) for interfacing a side sill of a vehicle (e.g., the left side sill extending along a longitudinal axis of the vehicle). Similarly, the linear portion 102B can have a distal end (here the end opposite the arched portion 104) for interfacing another side sill on the opposite side of the vehicle (e.g., the right side sill). The arched portion 104 can couple respective proximate ends of the linear portions 102A-102B to each other. For example, the structural crossmember 100 has a substantially linear shape so that it extends between the respective side sills.

The structural crossmember 100 can include mounts for various purposes. For any mount described herein the structural crossmember 100 can have at least one corresponding mount at a symmetrically located position elsewhere on the structural crossmember 100. Here, the structural crossmember 100 has mounts 106A-106B for seat rails, and one or more mounts 108 for another vehicle component. The mounts 106A-106B and 108 can face toward a passenger cabin of the vehicle. For example, each of the mounts 106A-106B can be used for securing a seat rail to the body of the vehicle (e.g., the two rails supporting one of the front-row seats in the vehicle). As another example, the mount(s) 108 can be used for attaching a center console, a control module (e.g., for a passenger restraint system), or another passenger cabin component.

The structural crossmember 100 can include at least one mating surface for another component. In some implementations, this can facilitate the other component being a non-body component that is instead installed on the vehicle during general assembly. Here, the structural crossmember 100 has mating interfaces 110A-110B. Each of the mating interfaces 110A-110B can be substantially planar. For example, the mating interfaces 110A-110B can be configured to face toward a footwell positioned adjacent the structural crossmember 100 (e.g., the footwell for second-row seats). The mating interface 110A can be configured for interfacing with a first floor component, and the mating interface 110B can be configured for interfacing with a second floor component, the first and second floor components being alternatives to each other for the vehicle. Either or both of the mating interfaces 110A-110B can be positioned between the mounts 106A-106B. For example, this can allow advantageous interfacing between a floor component and the structural crossmember 100 so as to provide flexibility in footwell design and allow occupants generous space in the footwell.

The structural crossmember 100 can include one or more mounts for a battery pack of the vehicle. A battery pack can be mounted below a passenger cabin floor of the vehicle and can be at least in part suspended and/or otherwise supported by the structural crossmember 100. As such, the mount(s) for the battery pack can be positioned on a side of the structural crossmember 100 that is opposite of the side having the mount(s) for the passenger cabin component(s). Here, the structural crossmember 100 has mounts 112A-112D for a battery pack. In some implementations, the mount 112A, 112B, 112C, and/or 112D can be configured to be attached to the battery pack inside a valley formed in the battery pack. For example, the structural crossmember 100 can provide a sill-to-sill cross-vehicle loadpath outside the battery pack in addition to any crossmembers inside the battery pack. The structural crossmember 100 can include one or more ribs 114 on either or both sides. That is, at least one side of the structural crossmember 100 can be at least partially pocked or cored. In some implementations, the rib(s) 114 can terminate at one or more of the mounts 112A-112D for the battery pack. For example, the rib(s) 114 can be formed in the casting process.

The structural crossmember 100 can be part of the vehicle body (e.g., to serve as a portion of the so-called body in white). In some implementations, the structural crossmember 100 can provide the main localization of the battery pack relative to the vehicle. Here, the structural crossmember 100 has one or more receptacles 116A-116B. The receptacles 116A-116B are positioned near (e.g., on the same side of the structural crossmember 100 as) the mounts 112A-112D. FIG. 1B shows that one of the receptacles 116A-116B (e.g., the receptacle 116A) can include a hole 118A (e.g., a circular opening), and the other one of the receptacles 116A-116B (e.g., the receptacle 116B) can include a slot 118B (e.g., an elongated opening). The hole 118A and the slot 118B can receive respective pins extending from the battery pack. Both the hole 118A and the slot 118B can constrain the respective pin of the battery pack in the x-direction, with reference to the shown coordinate system. In the y-direction, on the other hand, the hole 118A can constrain its respective pin more than what the slot 118B does because the slot 118B is oriented in the y-direction. As such, the structural crossmember 100 can serve as a master datum for the battery pack to the body in white, without over-constraining the battery pack. Examples of pins are mentioned below. In some implementations, one or more pins can also or instead be located on the structural crossmember 100, and one or more of the hole 118A or the slot 118B can also or instead be located on the battery pack.

The above examples illustrate that a structural crossmember (e.g., the structural crossmember 100) can include a crossmember configured to extend between a first side sill of a vehicle body and a second side sill of the vehicle body across from the first side sill. The crossmember can have (i) a first linear portion (e.g., the linear portion 102A) with a distal end at the first sill. The crossmember can have a second linear portion (e.g., the linear portion 102B) with a distal end at the second side sill. The crossmember can have an arched portion (e.g., the arched portion 104) that couples respective proximate ends of the first and second linear portions to each other. The structural crossmember can have a first mount (e.g., the mount 106A, 106B, and/or 108) for a passenger cabin component, the first mount positioned on a first side of the crossmember facing toward a passenger cabin of the vehicle. The structural crossmember can have a second mount (e.g., the mount 112A, 112B, 112C, and/or 112D) for the battery pack, the second mount positioned on a second side of the crossmember opposite from the first side.

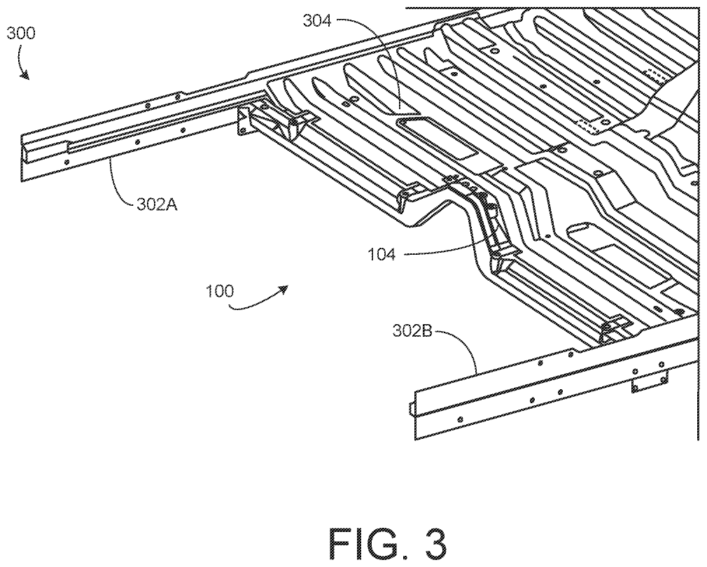

FIG. 3 shows an example of a vehicle 300 with the structural crossmember 100 of FIG. 1A. The vehicle 300 can be used with one or more other examples described elsewhere herein. The vehicle 300 is here partially shown, whereas not the entire vehicle body is visible, and components such as passenger cabin, powertrain, and wheels are omitted for clarity. The body of the vehicle 300 (sometimes referred to as the body in white) can include a number of structural features that form the basis for the vehicle 300 and on which the vehicle's components are mounted. Here, the vehicle body includes side sills 302A-302B. The side sills 302A-302B can be made from a material of sufficient strength to serve as structural member, including but not limited to one or more metals. In some implementations, the side sills 302A-302B are made of aluminum (e.g., an aluminum alloy). For example, the side sills 302A-302B can be extruded from aluminum. The vehicle body includes one or more floor panels 304. The floor panel(s) can serve as the part of the vehicle body where the passenger cabin is created and on which components such as seats are installed. The arched portion 104 of the structural crossmember 100 can provide an opening for one or more components of the vehicle 300. For example, tubes or other conduits, and/or busbars, can extend through the arched portion 104 to a battery pack mounted at least in part under the floor panel(s) 304.

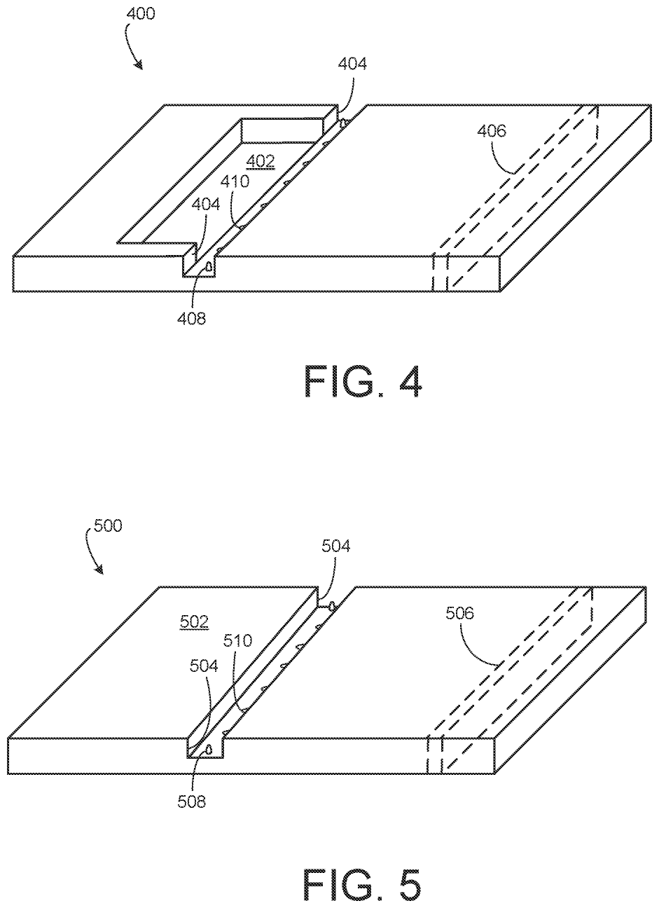

FIGS. 4-5 schematically show examples of battery packs 400 and 500 with a cavity portion 402 and a non-cavity portion 502, respectively. The battery pack 400 and/or 500 can be used with one or more other examples described elsewhere herein. Each of the battery packs 400 and 500 can be formed by an enclosure that houses an energy storage system (including, but not limited to, electrochemical cells). The enclosure(s) can have any shape compatible with the vehicle where it is to be used, and the shapes shown (i.e., substantially prismatic geometries in the form of rectangular solids) are used for illustrative purposes only.

The cavity portion 402 is an area where the battery pack 400 does not contain any structure (e.g., no electrochemical cells are positioned in the cavity portion 402). As such, the cavity portion 402 can be used with a vehicle that is to have a cavity footwell. For example, the cavity portion 402 can provide extended footwell space for a passenger in a second or third row of seats.

The battery pack 400 can have a valley 404 formed in the enclosure. The valley 404 extends from a first side (e.g., a longer side) of the battery pack 400 to a second side (e.g., a corresponding longer side across the battery pack). As such, the valley 404 defines an open passage from side to side in the battery pack 400 and can be referred to as a side-to-side valley. The valley 404 can at least in part extend through the cavity portion 402. A structural element such as the structural crossmember 100 of FIG. 1A can extend through the valley 404 at least in part. One or more mounts on the structural crossmember 100 (e.g., any of the mounts 112A-112D in FIG. 2) can be used for attaching the battery pack 400 to the structural crossmember 100 and thereby to the rest of the vehicle body. Such approaches can allow the structural crossmember 100 to serve as a cross-vehicle loadpath from sill to sill, and as a mount for not only the battery pack 400 but also other vehicle components. Such structural loadpath across the vehicle accommodated by the valley 404 can be in addition to any crossmember 406 (here shown in phantom) which may be positioned inside the battery pack 400.

Turning now to the battery pack 500, it contains structure at the non-cavity portion 502 (e.g., enclosure material and/or electrochemical cells). As such, the non-cavity portion 502 can be used with a vehicle that is to have a non-cavity footwell. For example, additional electrochemical cells in the non-cavity portion 502 provide extra range for the vehicle.

The battery pack 500 can have a valley 504 formed in the enclosure. The valley 504 extends from a first side (e.g., a longer side) of the battery pack 500 to a second side (e.g., a corresponding longer side across the battery pack). As such, the valley 504 defines an open passage from side to side in the battery pack 500 and can be referred to as a side-to-side valley. A structural element such as the structural crossmember 100 of FIG. 1A can extend through the valley 504 at least in part. One or more mounts on the structural crossmember 100 (e.g., any of the mounts 112A-112D in FIG. 2) can be used for attaching the battery pack 500 to the structural crossmember 100 and thereby to the rest of the vehicle body. Such approaches can allow the structural crossmember 100 to serve as a cross-vehicle loadpath from sill to sill, and as a mount for not only the battery pack 500 but also other vehicle components. Such structural loadpath across the vehicle accommodated by the valley 504 can be in addition to any crossmember 506 (here shown in phantom) which may be positioned inside the battery pack 500.

The battery packs 400 and 500 can have one or more pins 408 or 508, respectively. In some implementations, the pin 408 or 508 can fit into a respective one of the hole 118A or the slot 118B in FIG. 1B. For example, this can allow a structural member to serve as the master datum for the battery packs 400 or 500, respectively. The pin 408 and/or 508 can have any shape that is compatible with any of the hole 118A or the slot 118B, respectively. In some implementations, one or more of the pins 408 or 508 can also or instead be positioned on the structural member.

The battery packs 400 and 500 can have one or more fixing points 410 or 510, respectively. In some implementations, the fixing point 410 or 510 can correspond to (e.g., match) with any of the mounts 112A-112D in FIG. 2. This can allow the battery packs 400 or 500, respectively, to be secured to the respective structural member. For example, one or more bolts can be inserted into the battery pack 400 or 500 from below, so as to extend through the fixing point 410 or 510, respectively, and engage with any of the mounts 112A-112D.

The above examples illustrate that a vehicle (e.g., the vehicle 300 in FIG. 3) can include a vehicle body (e.g., as partially shown in FIG. 3) comprising a first side sill (e.g., the side sill 302A) positioned across from a second side sill (e.g., the side sill 302B). The vehicle body can have a passenger cabin floor (e.g., the floor panel 304) between the first and second side sills. The vehicle can include a battery pack (e.g., the battery pack 400 or 500) mounted below the passenger cabin floor, the battery pack having a side-to-side valley (e.g., the valley 404 or 504). The vehicle can include a structural crossmember (e.g., the structural crossmember 100) configured to extend between the first and second side sills. At least part of the structural crossmember can be positioned within the side-to-side valley.

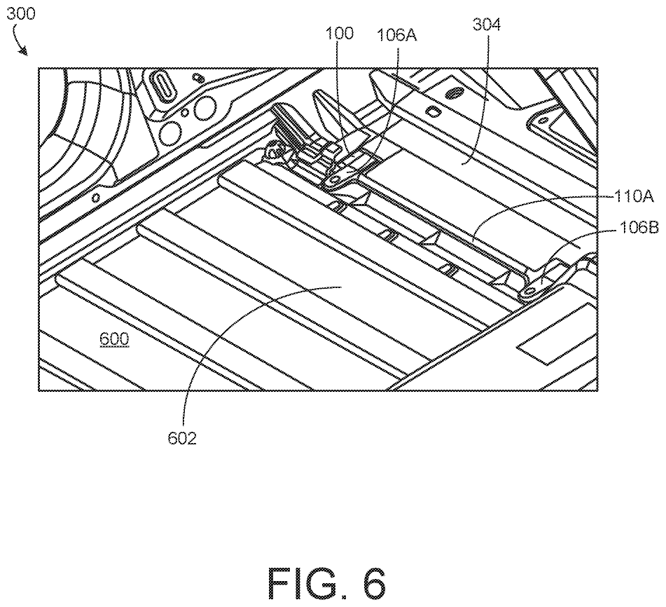

FIG. 6 shows the vehicle 300 of FIG. 3 having a non-cavity footwell 600 and a floor component 602 interfacing with the structural crossmember 100 of FIG. 1A. The non-cavity footwell 600 and/or the floor component 602 can be used with one or more other examples described elsewhere herein. The structural crossmember 100 is here largely obscured by the floor component 602 and the floor panel 304. Nevertheless, the mating interface 110A is partially visible. The floor component 602 interfaces with the mating interface 110A and extends partially around each of the mounts 106A-106B (e.g., the mounts for seat rails). Particularly, the floor component 602 can cover the non-cavity portion 502 of the battery pack 500 in FIG. 5 to provide the vehicle 300 with the non-cavity footwell 600. With this approach, the floor component 602 need not be a part of the vehicle body but rather can be installed in general assembly.

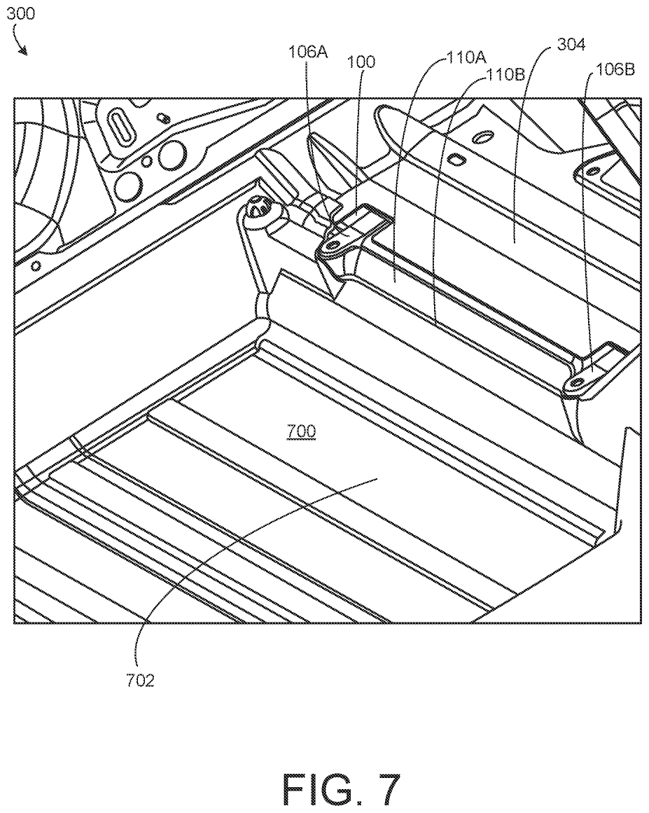

FIG. 7 shows the vehicle 300 of FIG. 3 having a cavity footwell 700 and a floor component 702 interfacing with the structural crossmember 100 of FIG. 1A. The cavity footwell 700 and/or the floor component 702 can be used with one or more other examples described elsewhere herein. The structural crossmember 100 is here largely obscured by the floor component 702 and the floor panel 304. Nevertheless, the mating interface 110A is visible and the mating interface 110B is partially visible. The floor component 702 interfaces with the mating interface 110B and extends partially around each of the mounts 106A-106B (e.g., the mounts for seat rails). Particularly, the floor component 702 can extend into the cavity portion 402 of the battery pack 400 in FIG. 4 to provide the vehicle 300 with the cavity footwell 700. With this approach, the floor component 702 need not be a part of the vehicle body but rather can be installed in general assembly.

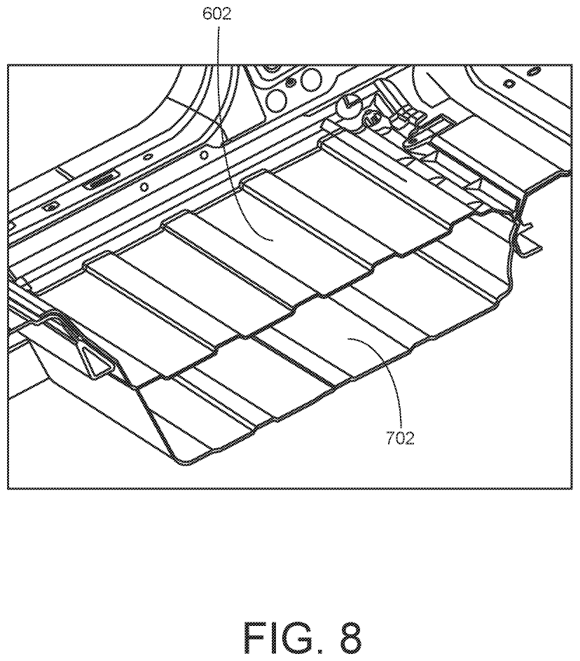

FIG. 8 schematically shows a cross section of a footwell having the floor components 602 and 702 of FIGS. 6-7, respectively. That is, the floor components 602 and 702 may be alternatives for the vehicle, and the present illustration shows them simultaneously to exemplify the non-cavity footwell 600 of FIG. 6 and the cavity footwell 700 of FIG. 7.

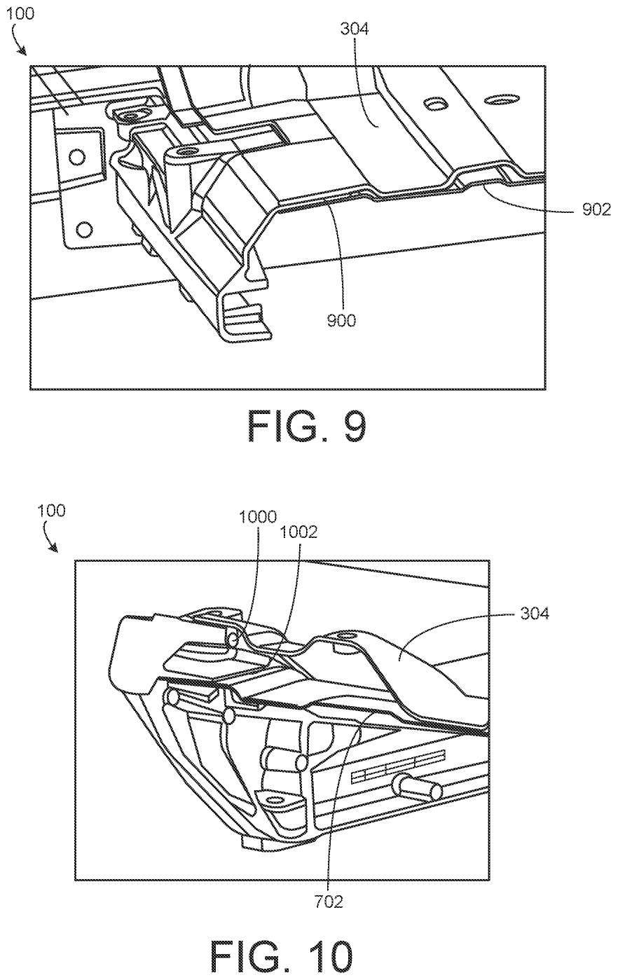

FIGS. 9-10 show example cross sections of the structural crossmember 100 of FIG. 1A. The structural crossmember 100 can include one or more flanges. The flange can be positioned on any side of the structural crossmember 100, including but not limited to a side where the mount(s) for the passenger cabin component(s) can be positioned. For example, the flange can be on the same side as the mounts 106A, 106B, and/or 108 in FIG. 1A.

Here, the structural crossmember 100 has a flange 900. The flange 900 can be substantially parallel with the floor panel 304. The flange 900 can be positioned on either or both of the linear portions 102A-102B in FIG. 1A. The floor panel 304 can be an upper floor panel and the vehicle may also have a floor panel 902 (e.g., a lower floor panel). The flange 900 can be characterized as a single flange. There is relatively little spacing between the floor panels 304 and 902, which both interface with the flange 900.

The structural crossmember 100 can also or instead have flanges 1000 and 1002. The flanges 1000 and 1002 can be substantially parallel with the floor panel 304. The flanges 1000 and 1002 can be positioned on the arched portion 104 in FIG. 1A. The flanges 1000 and 1002 can be characterized as a dual flange in that the floor panel 304 interfaces with the flange 1000, and the floor panel 902 interfaces with the flange 1002. As such, some spacing exists between the floor panels 304 and 902 at least in the vicinity of the structural crossmember 100.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A structural crossmember with battery pack mounting for a vehicle, the structural crossmember comprising:
a crossmember configured to extend between a first side sill of a vehicle body and a second side sill of the vehicle body across from the first side sill, the crossmember having (i) a first linear portion with a distal end at the first sill, (ii) a second linear portion with a distal end at the second side sill, and (iii) an arched portion that couples respective proximate ends of the first and second linear portions to each other;
a first mount for a passenger cabin component, the first mount positioned on a first side of the crossmember facing toward a passenger cabin of the vehicle; and
a second mount for the battery pack, the second mount positioned on a second side of the crossmember opposite from the first side.

2. The structural crossmember of claim 1, wherein the crossmember further comprises a first mating interface configured for interfacing with a first floor component, and a second mating interface configured for interfacing with a second floor component, the first and second floor components being alternatives to each other for the vehicle.

3. The structural crossmember of claim 2, wherein the first floor component corresponds to the vehicle having a non-cavity footwell.

4. The structural crossmember of claim 2, wherein the second floor component corresponds to the vehicle having a cavity footwell.

5. The structural crossmember of claim 2, wherein the first mount comprises first and second seat rail mounts.

6. The structural crossmember of claim 5, wherein the first and second mating interfaces are positioned between the first and second seat rail mounts.

7. The structural crossmember of claim 1, wherein the crossmember further comprises a flange on the first side, the flange substantially parallel with a floor of the vehicle.

8. The structural crossmember of claim 7, wherein the flange comprises respective single flanges on the first and second linear portions.

9. The structural crossmember of claim 7, wherein the flange comprises a dual flange on the arched portion.

10. The structural crossmember of claim 1, further comprising one of a receptacle or pin configured for the structural crossmember to serve as a master datum for the battery pack, wherein the battery pack has the other of the receptacle or the pin.

11. The structural crossmember of claim 10, wherein the structural crossmember has two receptacles corresponding to two respective pins that are located on the battery pack, one of the receptacles being a circular opening and the other receptacle being an elongated opening oriented in a y-direction of the vehicle.

12. A vehicle comprising:
a vehicle body comprising a first side sill positioned across from a second side sill, the vehicle body having a passenger cabin floor between the first and second side sills;
a battery pack mounted below the passenger cabin floor, the battery pack having a side-to-side valley; and
a structural crossmember configured to extend between the first and second side sills, wherein at least part of the structural crossmember is positioned within the side-to-side valley.

13. The vehicle of claim 12, wherein the crossmember further comprises a first mating interface configured for interfacing with a first floor component, and a second mating interface configured for interfacing with a second floor component, the first and second floor components being alternatives to each other for the vehicle.

14. The vehicle of claim 13, wherein the battery pack is configured for the vehicle to have a non-cavity footwell, and wherein the first floor component corresponds to the non-cavity footwell.

15. The vehicle of claim 13, wherein the battery pack is configured for the vehicle to have a cavity footwell, and wherein the second floor component corresponds to the cavity footwell.

16. The vehicle of claim 12, wherein the structural crossmember further comprises a first mount for a passenger cabin component, the first mount positioned on a first side of the crossmember facing toward a passenger cabin of the vehicle.

17. The vehicle of claim 16, wherein the first mount comprises first and second seat rail mounts.

18. The vehicle of claim 17, wherein first and second mating interfaces are positioned between the first and second seat rail mounts.

19. The vehicle of claim 12, wherein the structural crossmember comprises (i) a first linear portion with a distal end at the first sill, (ii) a second linear portion with a distal end at the second side sill, and (iii) an arched portion that couples respective proximate ends of the first and second linear portions to each other.

20. The vehicle of claim 19, wherein the vehicle body further comprises a first floor panel, and wherein the structural crossmember further comprises a flange for interfacing the first floor panel.

21. The vehicle of claim 20, wherein the flange comprises respective single flanges on the first and second linear portions interfacing the first floor panel.

22. The vehicle of claim 20, wherein the vehicle body further comprises a second floor panel, and wherein the flange comprises a dual flange on the arched portion, the dual flange comprising a first flange interfacing the first floor panel, and a second flange interfacing the second floor panel.

23. The vehicle of claim 12, wherein the structural crossmember further comprises one of a receptacle or pin configured for the structural crossmember to serve as a master datum for the battery pack, wherein the battery pack has the other of the receptacle or the pin.

24. The vehicle of claim 23, wherein the structural crossmember has two receptacles for two respective pins on the battery pack, one of the receptacles being a circular opening and the other receptacle being an elongated opening oriented in a y-direction of the vehicle.

25. The vehicle of claim 12, wherein the structural crossmember further comprises mounts for the battery pack, and wherein battery pack further comprises fixing points corresponding to the mounts.
